(19) United States
(12) Patent Application Publication
(10) Pub. No.: US 2009/0092710 A1
(43) Pub. Date: Apr. 9, 2009

(54) Nutritional Supplement

(75) Inventor: Roland Glaser, Quito (EC)

Correspondence Address: ROTHWELL, FIGG, ERNST & MANBECK, P.C., 1425 K STREET, N.W., SUITE 800, WASHINGTON, DC, 20005, US

(73) Assignees: Christian Huber, Muenchen (DE); Roland Glaser, Victoria, Quito (EC)

(21) Appl. No.: 11/722,150

(22) PCT Filed: Dec. 19, 2005
(86) PCT No.: PCT/EP05/13675

§ 371 Date: Jun. 19, 2007

(30) Foreign Application Priority Data
Dec. 20, 2004 (DE) 10 2004 061 309.5

(51) Int. Cl. A23L 1/29; A23L 1/302; A23L 1/304

(52) U.S. Cl. 426/72; 426/648

(57) ABSTRACT

The present invention relates to a nutritional supplement, comprising plant material of Mascagnia eggersiana, subspecies, ecotypes or a combination thereof. Preferably, the nutritional supplement is at least in part a shaped product.

The present invention relates to a nutritional supplement.

Nutritional supplements are generally known. They serve substantially for supplying substances to the body, which are not supplied by the usual diet, or are supplied in insufficient dosage, respectively. Such substances may be essential, as is the case for certain vitamines or minerals, or may be non-essential, whereby non-essential substances exert a positive, generally not more clearly defined influence on wellness and/or health. Examples of such nutritional supplements are for example agents containing vitamines and/or minerals, ginseng, guarana, agents based on herbs, etc.

It now has been found that Mascagnia eggersiana (Nied.) W. R. Anderson (in the following abbreviated as Mascagnia eggersiana) is suitable as a nutritional supplement.

Mascagnia eggersiana is a plant of the plant family Malphigiaceae, its existence has been reliably established for the Napo province in Ecuador, and it naturally grows in an area which at least extends along the Eastern slopes of the Andes of Ecuador in an altitude of 500-600 m and less. No information regarding a further extension of its natural distribution area is presently available. As used in the present application, the term Mascagnia eggersiana comprises the subject species as well as ecotypes and subspecies thereof. The terms “ecotype” and “subspecies” are used herein in the usual meaning.

A reference sample of Mascagnia eggersiana may be found in Germany at least in the national botanical collection (Botanische Staatssammlung) of Munich, abroad of Europe reference samples may be found at least in several botanical institutes within the USA. A specimen of Mascagnia eggersiana is presently cultured at the botanical institute of the University of Munich.

It now has been found out that taking Mascagnia eggersiana results in a generally increased wellness.

The nutritional supplement according to the present invention thus comprises plant material of Mascagnia eggersiana, subspecies, ecotypes or a combination thereof. The plant material usually will be in a dried form, and may be present in the form of substantially intact plant components, such as leaves or the root, or in a chopped up or ground form. Chopped up or ground dried plant material generally has a particle size in the range of from 0.5 to 8 mm in the longest dimension, or is a powder having a particle size smaller than 0.5 mm. When chopping up or grinding the plant material, woody components may be suitably removed, such as the woody stalk of the root.

According to one embodiment the nutritional supplement according to the present invention is at least in part a shaped product. According to the present application, a “shaped product” is understood to comprise both a substantially regularly shaped product and an irregularly shaped product. Regularly shaped products include for example capsules, dragees, tablets, etc., and irregularly shaped products include for example flakes, crunchies and other shapes known in the cereals industry, as well as cookies and the like. Bars (chocolate bar, cereal bar, candy bar) usually have a substantially regular shape, in particular cereal bars, however, exhibit an irregularly shaped surface, as compared to capsules etc. In addition to the chopped up or ground plant material the shaped products may comprise suitable binders, carriers, thickening agents or combinations thereof. Such additives are well known in food technology and accordingly will not be explained in detail herein.

According to this embodiment the nutritional supplement according to the present invention is at least in part a shaped product, i.e. at least 10 weight percent, preferably at least 40 weight percent and more preferably at least 60 weight percent of the nutritional supplement are a shaped product as defined above. Generally at least 75 weight percent will be a shaped product, and according to a particular embodiment, the nutritional supplement according to the present invention substantially is a shaped product. The term “substantially” in this context means that the nutritional supplement has been manufactured entirely as a shaped product, but nevertheless may contain dust and/or small particles, which are the result from abrasion or mechanical damage of the shaped products.

The size of the shaped products depends on the particular shape, and is conventional. Flakes for example generally have a diameter of greater than 8 mm to about 40 mm in the longest dimension, and a thickness of 0.3 to 3 mm. Cookies are available in a great variety of shapes, with dimensions of from 2 mm in the shortest dimension to 60 mm in the longest dimension. Cereal bars generally have dimensions between 5 mm in the shortest dimension and 150 mm in the longest dimension.

The manufacturing of shaped products is well known from the field of food technology, and further explanations therefore are not deemed to be necessary. Generally the material will be chopped up, ground to a powder if desired, and mixed with optional additional components and/or liquid to a paste-like consistency, und thereafter subjected to a suitable shaping method.

The nutritional supplement according to the present invention generally comprises at least 5 weight percent plant material of Mascagnia eggersiana, subspecies, ecotypes or a combination thereof, preferably at least 20 weight percent, more preferably at least 30 weight percent. According to a particular embodiment, the nutritional supplement according to the present invention comprises up to 65 weight percent, for example up to 90 weight percent of the plant material, optionally up to 95 weight percent, and according to a another particular embodiment the nutritional supplement according to the present invention substantially consists of plant material of Mascagnia eggersiana, subspecies, ecotypes or a combination thereof. The term “substantially” in this context means that binders, carriers and/or thickening agents optionally may be present.

According to a particular embodiment, the nutritional supplement according to the present invention furthermore is enriched with vitamines, provitamines, minerals, trace elements or a combination thereof. The term “enriched”, as used in the present application, means that such substances are present in the final product in a higher level as compared to the naturally occurring level in the plant material according to the invention. The enrichment is achieved by addition of the respective substance or substances in pure form, synthetic or natural, or by addition of a synthetic or natural composition, which contains one or more of the substances in question in a higher level than the plant material according to the invention.

If the nutritional supplement according to the present invention is enriched with vitamines, provitamines, minerals, trace elements or a combination thereof, the respective substances preferably are present in an amount such that 100 g of the nutritional supplement cover at least 25% of the minimum daily requirement of an adult, for example at least 50%, and optionally up to 100% or in excess thereof.

The following table summarizes examples of vitamines and minerals, together with the amount, which covers the recommended daily requirement (as recommended by the European Community).

TABLE 1

| substance | recommended daily requirement (EU) | |
|---|---|---|
| vitamin A | 0.8 | mg |
| vitamin B1 | 1.4 | mg |
| vitamin B2 | 1.6 | mg |
| vitamin B6 | 2.0 | mg |
| vitamin B12 | 0.001 | mg |
| pantothenic acid | 6.0 | mg |
| folic acid | 0.2 | mg |
| niacin | 0.018 | mg |
| vitamin C | 60.0 | mg |
| vitamin E | 10.0 | mg |
| biotin | 0.150 | mg |
| calcium | 800 | mg |
| iron | 14 | mg |
| magnesium | 300 | mg |
| zinc | 15 | mg |
| iodine | 150 | mg |

Further examples include, for instance, vitamin K1, und trace elements such as manganese, molybdenum and selenium. Examples of provitamins are β-carotene (provitamin A) and ergosterin as well as dehydrocholesterol (provitamin D).

According to a further embodiment the nutritional supplement according to the present invention additionally comprises fruits having hard shells, cereal products, dried fruits, fibres or a combination thereof. Fruits having hard shells include for example almond, hazelnut, walnut, cashewnut, macadamia nut, pecannut, peanut, Brazil nut, coconut, etc. Cereal products include for example products based on wheat, rice, maize, oats, rye, etc. Dried fruits include for example apple, berries, pineapple etc. Fibres are substances, which the human body cannot digest, but which exert a positive influence on digestion. Examples are generally plant framework or support substances, for example polysaccharides, celluloses, hemicelluloses, lignin, pectin, agar-agar and guar gum.

Other optional components are seeds, such as sesame or poppy seeds, pumpkin seeds, or also natural products such as ginseng, guarana, herbs or extracts thereof.

Furthermore, the nutritional supplement according to the present invention may contain flavours, cacao products and milk products, and may contain sweetening agents. As a sweetening agent, common sugars such as glucose and fructose are suitable, as are sweeteners such as for example saccharin, cyclamate and aspartame, and sugar replacement substances, such as sorbitol, mannitol and xylitol. The nutritional supplement according to the present invention is preferably suitable for diabetics.

The plant material of Mascagnia eggersiana, subspecies, ecotypes or a combination thereof, may be obtained from young plants, which may be reproduced from cuttings, for example. Such young plants have the morphology of a bush having a diameter of from about 0.3 to 1.2 m, whereas in later development stages Mascagnia eggersiana forms shoots having a height of several meters. According to one embodiment, the Mascagnia eggersiana plant material of the nutritional supplement according to the present invention is derived from young plants, for example young plants having a height above the ground of less than 1,2 m, in particular having a height above the ground of from 0.3 to 1 m.

According to a particular embodiment, the plant material is derived from the root. Other parts of the plant, such as the plant body or the leaves are suitable as well, however.

1. A nutritional supplement, comprising plant material of Mascagnia eggersiana, subspecies, ecotypes or a combination thereof.

2. The nutritional supplement of claim 1, characterized in that it is at least in part a shaped product.

3. The nutritional supplement of claim 2, characterized in that it is substantially a shaped product.

4. The nutritional supplement of claim 1, characterized in that it is enriched with vitamines, provitamines, minerals, trace elements or a combination thereof.

5. The nutritional supplement of claim 1, characterized in that it furthermore comprises fruits having hard shells, cereal products, dried fruits, fibres, seeds or a combination thereof.

6. The nutritional supplement of claim 1, characterized in that it comprises said plant material in an amount of from 5 to 100 weight percent, based on the total weight of the nutritional supplement.

7. The nutritional supplement of claim 6, characterized in that said plant material is present in an amount of from 10 to 95 weight percent.

8. The nutritional supplement of claim 1, characterized in that said plant material is derived from young plants.

9. The nutritional supplement of claim 1, characterized in that said plant material is derived from the root.

10. A bar, comprising plant material of Mascagnia eggersiana, subspecies, ecotypes or a combination thereof.

11. The bar of claim 10, characterized in that it comprises said plant material in an amount of from 5 to 100 weight percent, based on the total weight of the nutritional supplement.

12. The bar of claim 11, characterized in that it comprises said plant material in an amount of from 10 to 95 weight percent.

13. The bar of claim 10, further comprising an addition of vitamines, provitamines, minerals, trace elements or a combination thereof.

14. The bar of claim 10, further comprising fruits having hard shells, cereal products, dried fruits, fibres or a combination thereof.

15. The bar of claim 10, further comprising guarana.

16. Use of plant material of Mascagnia eggersiana, subspecies, ecotypes or a combination thereof as a nutritional supplement.
